(19) United States
(12) Patent Application Publication
(10) Pub. No.: US 2025/0302010 A1
(43) Pub. Date: Oct. 2, 2025

(54) ROTATION OPENS THE CHICKEN CAGE DOOR

(71) Applicant: Ningbo Xingzhou Intelligent Manufacturing Co., Ltd., Ningbo (CN)

(72) Inventor: Yuanxing SHAO, Jinhua (CN)

(73) Assignee: Ningbo Xingzhou Intelligent Manufacturing Co., Ltd., Ningbo (CN)

(21) Appl. No.: 18/629,993

(22) Filed: Apr. 9, 2024

(30) Foreign Application Priority Data
Mar. 27, 2024 (CN) 2024206113036

(51) Int. Cl. A01K 31/02; A01K 31/00

(52) U.S. Cl. CPC A01K 31/02; A01K 31/002

(57) ABSTRACT

A chicken cage door is provided, which includes a door frame and a door plate, the door plate is provided with a rotating shaft, the rotating shaft passes through the door plate and is embedded in two sides of the door frame; the door plate follows a rotation of the rotating shaft; a module box is provided on an upper side of the door box, and the module box has a drive motor, an output shaft of the drive motor is provided with a worm wheel, the worm wheel is engaged with a worm shaft, and the door plate is rotated by the worm wheel and the worm shaft. The door panel is driven by the drive motor in the module box and is rotated with the rotating shaft to realize an opening of the door panel.

### TECHNICAL FIELD

The present disclosure belongs to the field of poultry breeding products, and involves the chicken cage door, specifically a rotating open chicken cage door.

### BACKGROUND

The chicken cage gate is a common rural or farm facility for raising poultry (such as chickens, ducks, etc.). It is a structure similar to the gate used to limit the range of poultry and provide safety and protection. Cage doors are usually made of metal wire mesh or wood with air permeability and visibility to observe poultry.

Chicken cage door is generally manually switched, in the actual use process, there is a problem of inconvenient operation. Therefore, the electric chicken cage door has become a popular product in the market, the commonly used electric chicken cage door, the middle of the door plate is set with neatly arranged holes, the top of the chicken cage door control component is set with a motor and gear, gear and hole mesh, motor drive gear rotation, gear rotation at the same time drive the door plate lift. Although this structure realizes the function of automatic lifting of the chicken cage door plate, the door plate is only supported by the gear position of the gear, which is in a suspended state with poor stability. And in the lifting process of the door plate, when the gear jamming of the gear and the hole cooperate, the collision will produce a loud sound, and with the increase of the use of the time, the gear will not drive the door plate lifting, serious when the door plate will fall off, fall off easy to smash or kill the birds on the lower side of the gear.

### SUMMARY

In order to remedy the shortcomings of the prior technology, the present disclosure provides a technical scheme capable of automatically controlling the opening and closing of the chicken cage exit.

The rotary open the chicken cage door, including the door frame and the door panel, the door plate is provided with the rotation shaft, the door shaft from the door plate, and embedded on the two sides of the door plate with the rotation of the door box, the upper side of the door box is equipped with the module box, equipped with the drive motor, the output shaft of the drive motor is equipped with a worm wheel on the shaft, the worm wheel and the worm shaft mesh connection, through the worm wheel and the worm shaft, the door plate and the drive motor transmission connection, drive the door plate rotation.

Further, the assembly table is fixed in the inner chamber of the module box, the drive motor is fixed on one side of the assembly table, and the output shaft of the drive motor is inserted to the inner chamber of the assembly table. The worm shaft is limited in the inner chamber of the assembly table, one end is connected with the output shaft, and the other end is set in the slot of the assembly table.

Further, there is a worm wheel cavity in the middle of the assembly table, and the shaft sleeves are set on the upper and lower sides of the worm wheel cavity, the rotating shaft passes through the two shaft sleeves in turn, and the worm wheel is limited in the worm wheel cavity.

Further, the rotating shaft is equipped with the lower shaft sleeve, which is fixed on the lower side support pipe of the door frame, and the rotating shaft is inserted in the lower shaft sleeve.

Further, the door frame is set with the opening, and the rotating shaft is limited in the opening.

Further, the side of the door frame is set with slotted, the door panel is set on the side of the slotted, the door panel rotation angle is 0-180°.

Further, the internal setting of the module box is set with a locking component, which is set on the other side of the door panel, away from the rotating shaft setting. The locking component includes the locking motor and the lock column. The locking motor is connected to the lock column transmission. The locking motor can drive the lock column up and down against or through the door plate, and realize the locking.

Further, the top of the door plate is set with a through hole, and the lock column is matched with the through hole. In the lock state, the lock motor drives the lock column to drop and insert into the through hole to form a limit.

Further, the electromagnetic sensor is set on the inner wall of the door frame, and the electromagnetic signal transmitter is set on the door plate. Through the electromagnetic sensor and the electromagnetic sensor, the door plate controls the final position of the opening and closing process.

Further, the control panel is set on the surface of the module box, the control assembly is set in the inner chamber, the display screen is set on the control panel and the function button for adjusting the door opening mode.

The light sensor is also set on the side of the control panel.

Further, the control assembly comprises execution instructions to execute at least one control mode by which the chicken cage door is opened/closed, and the different control modes are adjusted by function buttons.

Further, the control mode includes the light sensing mode, the timing mode and the manual mode over the light sensing mode and timing mode, and the light sensing mode and timing mode can operate alternately.

Compared with the prior art, the present disclosure has the following advantages:

The door panel of this device is rotated to open. The door panel is driven by the drive motor in the top module box and rotates with the rotating shaft to realize the rotary opening of the door panel. The door frame is set with a slot. When the door panel rotates around the axis, it can reach 180° to make the door panel fully expanded. At this time, the door panel can fit the chicken house and will not affect the entry and exit of poultry. In addition, in the door plate in the opening process, open stability, there is no gear and door plate percussion sound.

The other side of the door panel is provided with a component for fixing the lock, which is locked by the lock column set in the module box with the through hole set in the door panel. In the locking state, the locking motor in the module box drives the lock column down until the lock column is plugged in the open hole to complete the door plate locking. At this time, the door plate will not rotate, and the animals on both sides of the door plate will have good stability, to avoid the accidental opening of the door plate and improve the protection.

### BRIEF DESCRIPTION OF DRAWINGS

FIG. 1 is a schematic diagram of the present disclosure.

FIG. 2 is a schematic diagram of the structure of the door panel opening state.

FIG. 3 is a schematic diagram of the present disclosure module box.

FIG. 4 is the schematic diagram of the locking component structure.

FIG. 5 shows a schematic diagram of the electromagnetic induction structure.

### DESCRIPTION OF EMBODIMENTS

The present disclosure is further explained in combination with the following drawings.

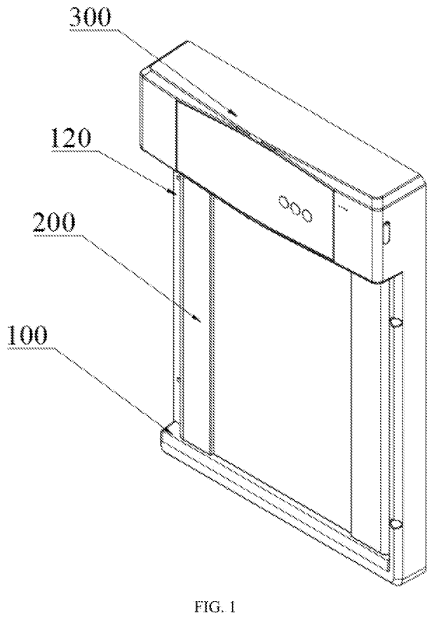

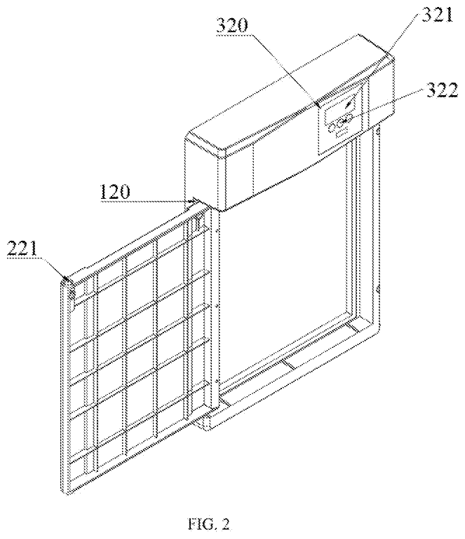

As shown in FIGS. 1-5, a rotary opening cage door includes a door frame 100 and a door plate 200 provided with a rotating shaft 210 running through the door plate 200 and inserted into the upper and lower sides of the door frame 100. The door frame 100 is provided with an opening 110, and the rotating shaft 210 is limited in the opening 110, and the door plate 200 follows the rotating shaft 210 to open or close. A slotted 120 is provided on one side of the door frame 100, the door panel 200 is provided on the side of the slotted 120, and the door panel 200 rotates at an angle of 0-180°. The rotating shaft 210 is provided with a lower shaft 211, which is fixed to the lower support pipe of the door frame 100, and the rotating shaft 210 is inserted in the lower shaft 211.

The rotation of the door plate 200 is that the door frame 100 is provided with the module box 300, the module box 300 is provided with the drive motor 400, the output shaft of the drive motor 400 has a worm shaft 410, a worm wheel 420 is provided on the rotating shaft 210, and the worm wheel 420 is engaged with the worm shaft 410. With the worm wheel 420 and the worm shaft 410, the door plate 200 forms a transmission connection with the drive motor 400, and the drive door panel 200 rotates.

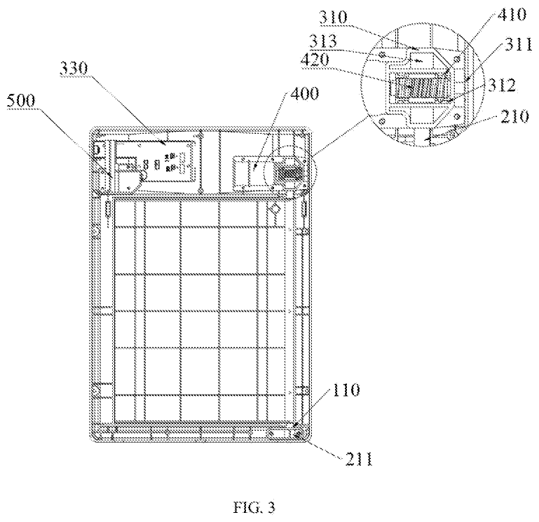

In connection with FIG. 3, an assembly table 310 is fixed in the inner cavity of the module box 300, and the drive motor 400 is fixed to the side of the assembly table 310, and the output shaft of the drive motor 400 is inserted into the inner cavity of the assembly table 310. The worm shaft 410 is confined in the inner cavity of the assembly table 310, one end is connected to the output shaft, and the other end is provided in the slot 311 of the assembly table 310. The assembly table 310 is provided in the middle of the worm wheel chamber 312, the shaft sleeve 313 is provided on the upper and lower sides of the worm wheel chamber 312, the rotary shaft 210 is successively through the two shaft sleeves 313, the worm wheel 420 is limited in the worm wheel chamber 312, and the worm wheel 420 is simultaneously connected to the rotary shaft 210.

The door panel of this device is rotated to open. The door panel is driven by the drive motor in the top module box and rotates with the rotating shaft to realize the rotary opening of the door panel. The door frame is set with a slot. When the door panel rotates around the axis, it can reach 180° to make the door panel fully expanded. At this time, the door panel can fit the chicken house and will not affect the entry and exit of poultry. In addition, in the door plate in the opening process, open stability, there is no gear and door plate percussion sound.

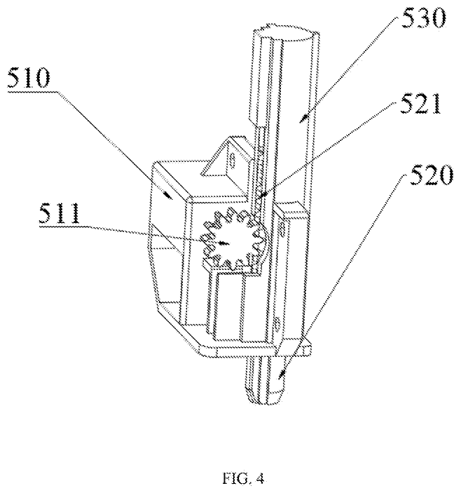

Continue to FIG. 4, the module box is equipped with the locking component 500, the lock assembly is located on the other side of the door panel, away from the rotating shaft setting, the lock component includes the locking motor 510 and the lock column 520, the lock motor drives the lock column up and down, down against the door plate or through the door plate, realize the locking. The through hole 221 is set at the top of the door plate. The lock column cooperates with the through hole. In the lock state, the lock motor drives the lock column to drop and inserts it into the through hole to form a limit. Specifically, the locking assembly 500 is composed of a mounting seat 530, the gear 511 is provided on the output shaft of the locking motor 510, clamp teeth 521 is provided on the side wall of the lock column 520, the gear 511 is engaged with the clamp teeth 521, and when the locking motor 510 is running, the lock column 520 is driven up and down by the gear 511 in the mounting seat 530.

In the locking state, the locking motor in the module box drives the lock column down until the lock column is plugged in the open hole to complete the door plate locking. At this time, the door plate will not rotate, and the animals on both sides of the door plate will have good stability, to avoid the accidental opening of the door plate and improve the protection.

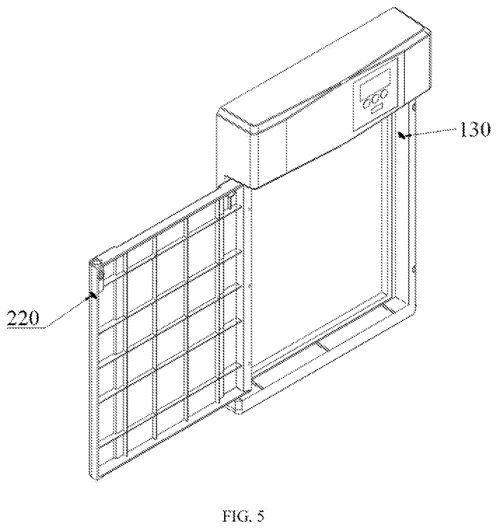

In connection with FIG. 5, a more preferred embodiment of the door frame 100 is provided with the electromagnetic sensor 130, and the electromagnetic signal transmitter 220 is provided with the electromagnetic sensor 130 and the electromagnetic signal emitter 220. In this embodiment, electromagnetic signal transmitters are provided on the left and right sides of the door panel, and electromagnetic sensors are provided on both sides of the door frame.

The specific control principle is that the electromagnetic signal receiver and the electromagnetic sensor are respectively connected to the control panel 320 in the module box. During the opening of the door plate, when the door plate rotates to 180°, the electromagnetic sensor disposed on the side of the rotating shaft 210 receives the signal from the electromagnetic signal transmitter on the same side, and then the received signal is feedback to the control panel 320, and the drive motor connected to the rotating shaft drive stops working. When the door panel is closed, when the door panel rotates to 0°, the electromagnetic sensor and electromagnetic signal transmitter set on the side of the locking component operate, and transmit the stop signal to the control panel to cause the drive motor to stop working. Through this structure, the rotation Angle of the door panel is accurately controlled between 0-180°, so as to avoid the output of the drive motor when the door panel is in 0° and 180°, resulting in the damage of the drive motor or the transmission connection between the rotating shaft and the drive motor.

The control panel 320 is provided with a module box 300, a control assembly 330 and the PCB circuit board, the control panel 320 is provided with a display screen 321, an indicator light and a function button 322 for adjusting the door opening mode, a side of the control panel 320 is also provided with a light sensor, and the display panel 321. Various control modes are provided in the control assembly. When use, the PCB circuit board will execute the execution instruction of at least one control mode for the cage door opening/closing, and the different control modes are adjusted by the function button 322. The control mode includes light sensing mode, timing mode and manual mode, manual mode priority is more than light sensing mode and timing mode, and light sensing mode and timing mode can run alternately.

The specific mode control mode is as follows: after startup, automatically count into the light sensing mode, and detect the ambient illumination through the light sensor. When the illumination of the external environment is above 15 lux, the driving motor 400 is turning, and the door plate 200 follows the rotation, and then the chicken cage door is automatically opened and the indicator light is green. The indicator light is turned off when the door panel is fully open for 3 s. When the illumination of the external environment is lower than 3 lux, when the drive motor reverses, the door plate 200 will be closed, and the indicator will turn red and continues for 3 s. In the light sensing mode, the display screen 321 is closed. Each time when the door plate 200 is opened, the indicator light is always on and the door panel 200 after the 3 S is closed. Each time the door plate 200 is closed, the indicator light is always red and the door is completely closed 3 S, the indicator light is closed.

The light-sensing mode can be converted to a timing mode. Specifically, by pressing the function button, the display screen 321 displays the timing opening and closing time. After completing the setting, the door plate 200 will automatically open and close according to the set time.

The light sensing mode or timing mode can be converted to manual mode, specifically to press the power button to awaken the display panel. In the case of awakening the device, press the function button respectively to open and close. In the awake state, the press is invalid and the door panel 200 does not respond. Also, manual opening and closing does not affect the time/light sensing setting.

When the power supply in the module box 300 is running out, the indicator light flashes red, indicating charging. A more preferred embodiment is a solar panel at the top of the module box 300 for charging during the day. Each time the chicken cage door is switched on and off, the mode set in the control module will restore the factory setting.

Through the above setting, you can realize opening the door in the light sense/timing mode, close the door in the light sense/timing mode, and realize four control modes. Also, in either mode, the door plate 200 may be switched in a manual mode.

1. A chicken cage door, including a door frame and a door panel,
the door panel is provided with a rotating shaft,
the rotating shaft passes from upper and lower sides of the door panel, and the rotating shaft is embedded in upper and lower sides of the door frame, the door panel follows a rotation of the rotating shaft to be opened or closed,
wherein a module box is provided on the upper side of the door frame, and the module box is provided with a drive motor, a worm shaft is provided on an output shaft of the drive motor,
a worm wheel is provided on the rotating shaft,
wherein the door panel is connected to the drive motor, and the door panel is driven to rotate by the worm wheel and the worm shaft;
when an illumination of an external environment is above 15 lux, the drive motor is rotated forward, and the door plate follows the rotation of the driven motor;
when the illumination of the external environment is lower than 3 lux, the drive motor is rotated reversed, the door plate is closed;
wherein the module box is provided with a locking assembly, and the locking assembly is provided on one side of the door plate away from the rotating shaft, the locking assembly comprises a lock motor and a lock column, the lock motor is connected to the lock column and drives the lock column to be lifted up and down;
when the lock column is lifted down, it abuts against the door plate or passes through the door plate;
wherein the locking assembly comprises a mounting seat a gear is provided on an output shaft of the lock motor, clamp teeth is provided on a side wall of the lock column, the gear is engaged with the clamp teeth, and when the lock motor is running, the lock column is driven to move up and down by the gear in the mounting seat.

2. The chicken cage door according to claim 1, wherein an assembly table is fixed in an inner cavity of the module box, the drive motor is fixed to one side of the assembly table, and the output shaft of the drive motor is inserted to an inner cavity of the assembly table, the worm shaft is located in the inner cavity of the assembly table, one end of the worm shaft is connected to the output shaft, and the other end of the worm shaft is set in an embedding slot of the assembly table.

3. The chicken cage door according to claim 2, wherein a worm wheel chamber is provided in a middle of the assembly table,
upper and lower sides of the worm wheel chamber are provided with shaft sleeves, the rotating shaft passes through the shaft sleeves, and the worm wheel is located in the worm wheel chamber.

4. The chicken cage door according to claim 1, wherein a lower shaft sleeve is fixed on the rotating shaft; the lower shaft sleeve is fixed on a lower support pipe of the door frame, and the rotating shaft is inserted in the lower shaft sleeve.

5. The chicken cage door according to claim 1, wherein an opening is provided on the door frame, and the rotating shaft is provided in the opening.

6. The chicken cage door according to claim 1, wherein one side of the door frame is provided with a slot, the door plate is provided on one side of the slot and a rotation angle of the door plate is 0-180°.

7. (canceled)

8. The chicken cage door according to claim 1, wherein a through hole is provided at a top of the door plate, the lock column cooperates with the through hole, the lock motor drives the lock column to be lifted down and is inserted into the through hole in a locking state.

9. The chicken cage door of claim 1, wherein an electromagnetic sensor is provided on an inner wall of the door frame, and an electromagnetic signal transmitter is provided on the door panel, an opening or a closing of the door panel is controlled through the door panel and the electromagnetic signal transmitter.

10. The cage door according to claim 1, wherein a surface of the module box is provided with a control panel, a control assembly is provided in the inner cavity of the module box, the control panel is provided with a display screen and a function key for adjusting a door opening mode;
a light sensor is also set on a side of the control panel.

11. The chicken cage door according to claim 10, wherein the control assembly comprises execution instructions to perform at least one control mode in which the chicken cage door is opened or closed by the at least one control mode.

12. The chicken cage door according to claim 11, wherein the at least one control mode includes a light sensing mode, a timing mode and a manual mode;
a priority of the manual mode is binger than that of the light sensing mode and the timing mode, and the light sensing mode and a timing mode are operated alternately.
